(19) United States
(12) Patent Application Publication
(10) Pub. No.: US 2015/0179090 A1
(43) Pub. Date: Jun. 25, 2015

(54) MULTIDIMENSIONAL LABEL HAVING A SHAPE INDICATIVE MARKER

(71) Applicant: Avishay BLANKITNY, Tel-Aviv (IL)

(72) Inventor: Avishay BLANKITNY, Tel-Aviv (IL)

(21) Appl. No.: 14/574,581

(22) Filed: Dec. 18, 2014

Related U.S. Application Data
(60) Provisional application No. 61/917,992, filed on Dec. 19, 2013.

(51) Int. Cl. G09F 3/02; G06T 7/00; G06K 7/10; G06K 19/06; G01B 11/06

(52) U.S. Cl. CPC G09F 3/02; G06K 19/06037; G06K 19/06056; G01B 11/0608; G06K 7/1092; G06T 7/0051; G06T 2207/10004

(57) ABSTRACT

A label comprising: a plurality of randomly positioned irregularly shaped three dimensional structures of unique structure parameters; and a plurality of structure parameter indicators each placed on top of one of the plurality of irregularly shaped three dimensional structures; wherein each structure parameter indicator facilitates a calculation of at least one structure parameter of the respective irregularly shaped three dimensional structure when a single two dimensional image of the label is processed.

### RELATED APPLICATION

This application claims the benefit of priority under 35 USC 119(e) of U.S. Provisional Patent Application No. 61/917,992 filed on Dec. 19, 2013, the contents of which are incorporated herein by reference in their entirety.

### FIELD AND BACKGROUND OF THE INVENTION

The present invention, in some embodiments thereof, relates to a three dimensional (3D) label and, more particularly, but not exclusively, to a 3D label having a structure parameter indicative marker.

The growing worldwide phenomena of goods counterfeit are causing a significant loss of income for consumer goods manufacturers and a fraud where consumers receive a low quality return instead of the original purchase. 2 dimensional (2D) labels that are attached to products are easily duplicated and therefore insufficient.

Many types of 3D labels exist that are more difficult to forge then 2D labels.

Some of these labels include randomly distributed elements which uniquely identify the product and its authenticity, and cannot be forged without special production equipment. Some of these labels may be identified and verified by the consumer using a common device such as a mobile phone equipped with a camera.

Known processes of identifying a 3D structure require at least two camera images in order to triangulate and calculate each point's 3D coordinates and restructure the original 3D body.

### SUMMARY OF THE INVENTION

According to some embodiments of the present invention there is provided a label comprising: a plurality of randomly positioned irregularly shaped three dimensional structures of unique structure parameters; and a plurality of structure parameter indicators each placed on top of one of the plurality of irregularly shaped three dimensional structures; wherein each structure parameter indicator facilitates a calculation of at least one structure parameter of the respective irregularly shaped three dimensional structure when a single two dimensional image of the label is processed.

Optionally, a size of each structure parameter indicator matches a size of respective the irregularly shaped three dimensional structure.

Optionally, the plurality of irregularly shaped three dimensional structures is of varying contours.

Optionally, the plurality of irregularly shaped three dimensional structures is of varying heights.

Optionally, the plurality of irregularly shaped three dimensional structures is of heights within a range of 0.2 millimeter and 0.7 millimeter.

Optionally, the plurality of irregularly shaped three dimensional structures is of varying sizes.

Optionally, the plurality of irregularly shaped three dimensional structures is of varying colors.

Optionally, the plurality of irregularly shaped three dimensional structures is positioned on top of a substrate layer.

More optionally, the substrate comprises a plurality of cuts to ensure destruction of the label on an attempt to detach the label from a product to which the label is attached.

Optionally, the plurality of irregularly shaped three dimensional structures is sensible by a finger touch, for manually validating the label authenticity.

Optionally, the label further comprises a two dimensional element.

More optionally, the two dimensional element is a quick response code.

More optionally, the two dimensional element is a logo of a company.

Optionally, the label further comprises a plurality of calibration marks for calculating a position of an imaging device acquiring the two dimensional image.

According to some embodiments of the present invention there is provided a method for verifying a height of an irregularly shaped three dimensional structure in a label, comprising: acquiring, by a camera, a single two dimensional image of a label having an irregularly shaped three dimensional structure with a height indicator positioned at a central geometric position on top of the irregularly shaped three dimensional structure; calculating a three dimensional relative position of the camera using positions of a plurality of calibration marks of the label in the single two dimensional image and predefined positions of the plurality of calibration marks; retrieving from a dataset the central geometric position; calculating a height of the height indicator using a position of the height indicator in the single two dimensional image, the central geometric position and the relative position of the camera; comparing the calculated height to a premeasured height of the height indicator to authenticate one of product and service associated with the label.

According to some embodiments of the present invention there is provided a system for verifying authenticity of a label, comprising: an imaging device for acquiring a two dimensional image of a label having plurality of randomly positioned irregularly shaped three dimensional structures of unique structure parameters and a plurality of structure parameter indicators each placed on top of one of the plurality of irregularly shaped three dimensional structures; a program for calculating at least one structure parameter of the plurality of irregularly shaped three dimensional structure when processing the single two dimensional image using the plurality of structure parameter indicators; and a database storing at least one structure parameter corresponding to the label.

According to some embodiments of the present invention there is provided a method for verifying authenticity of a label, comprising: providing a label having plurality of randomly positioned irregularly shaped three dimensional structures of unique structure parameters and a plurality of structure parameter indicators each placed on top of one of the plurality of irregularly shaped three dimensional structures; acquiring a two dimensional image of the label; processing the two dimensional image; calculating at least one structure parameter of the plurality of irregularly shaped three dimensional structure using the plurality of structure parameter indicator; comparing the at least one calculated structure parameter with at least one structure parameter corresponding to the label stored on a database; and determining authenticity of the label.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1A is an illustration of a three dimensional (3D) label, according to some embodiments of the present invention;

FIG. 1B is an illustration of a substrate layer, according to some embodiments of the present invention;

FIG. 2 is an illustration of a 3D label shaped as a triangle and a 3D label shaped as a square, according to some embodiments of the present invention;

FIG. 3 is an illustration of a 3D label with a quick response code (QR code), according to some embodiments of the present invention;

FIG. 4 is an image of an uncut substrate layer with 3D structures having structure parameter indicators, according to some embodiments of the present invention;

FIG. 5 is an illustration of the acquiring of an image of a label by a camera of a mobile phone, according to some embodiments of the present invention;

FIG. 6 is a flowchart schematically representing a method for verifying the height of an irregularly shaped three dimensional structure in a label, according to some embodiments of the present invention;

FIG. 7A is a schematic illustration of height calculation of an irregularly shaped three dimensional structure in a label, according to some embodiments of the present invention;

FIG. 7B is a top view of the irregularly shaped three dimensional structure of FIG. 7A;

FIG. 7C is a view of the irregularly shaped three dimensional structure of FIG. 7A in the 2D image taken when a camera is positioned to the right and slightly downwards relative to the top of the structure;

FIG. 7D is a side view of the irregularly shaped three dimensional structure of FIG. 7A;

FIG. 8 is an illustration of a system for verifying authenticity of a label, according to some embodiments of the present invention; and

FIG. 9 is a flowchart schematically representing a method for verifying authenticity of a label, according to some embodiments of the present invention.

### DESCRIPTION OF EMBODIMENTS OF THE INVENTION

The present invention, in some embodiments thereof, relates to a three dimensional (3D) label and, more particularly, but not exclusively, to a 3D label having a structure parameter indicative marker. The invention provides a method of verifying the authenticity of label by identifying 3D irregularly shaped structures with a single camera shot where the camera is placed at a random, angular position relative to the label.

According to some embodiments of the present invention, a label is provided, containing randomly positioned irregularly shaped 3D structures of unique structure parameters; and structure parameter indicators placed on top of the 3D structures, such as dots or lines of possibly different types of shapes and colors. The structure parameter indicators facilitates a structure parameter calculation of the 3D structure when a two dimensional (2D) image of the label is processed. The structure parameter indicators are used by a height-calculation algorithm as a point of reference to a structure parameter of each 3D structure.

According to some embodiments of the present invention, methods and systems are provided for verifying authenticity of a label. A 2D image of a label, having randomly positioned irregularly shaped 3D structures of unique structure parameters with structure parameter indicators, is taken. The image is taken by an imaging device, such as a camera of a mobile phone. The image is processed by a program, such as a mobile application, and structure parameters of the 3D structures are calculated by the program. The structure parameters are compared with data regarding the 3D structures of the label, stored on a database.

According to some embodiments of the present invention, there are provided methods and systems for verifying a height of an irregularly shaped 3D structure in a label. A single 2D image is acquired by a camera, of a label having an irregularly shaped 3D structure with a height indicator positioned at the maximal height of the structure. The position of the camera is calculated using the positions of calibration marks. The height of the structure is then calculated using the camera's position, the position of the height indicator and a central geometric position of the structure. The calculated height is then compared to a premeasured height of the structure to determine authenticity.

Using structure parameter indicators to facilitate structure parameter calculation allows accurate calculation and therefore provides labels that are difficult to counterfeit, as a duplicate label must be a very accurate copy of the original.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

As will be appreciated by one skilled in the art, aspects of the present invention may be embodied as a system, method or computer program product.

Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

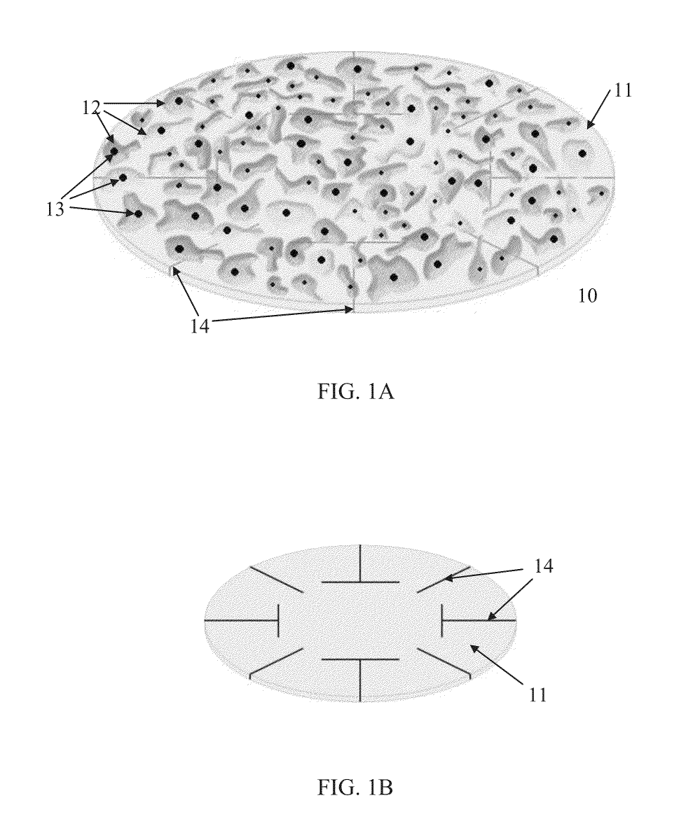

Referring now to the drawings, FIG. 1A is an illustration of a 3D label 10 having randomly positioned irregularly shaped 3D structures, each with a structure parameter indicator on its top for facilitating a structure parameter calculation of the 3D structures when a 2D image of the label is processed, according to some embodiments of the present invention.

Label 10 includes irregularly shaped 3D structures 12 of unique structure parameters. Structures 12 may be made polymer, or any material, for example, plastic, rubber or glass. Structure parameters may be, for example, position, contour, color, orientation, height and/or size. The unique structure parameters of structures 12 allow the manufacturing of many different labels of different structure parameters.

Optionally, structures 12 may be of varying positions, contours, colors, orientations, heights and/or sizes.

Structures 12 may be in any height, for example, 0.01, 0.1, 0.3, 0.7, 1, 2 millimeter (mm) or any intermediate or higher height. Optionally, the height of structures 12 is in the range of 0.2 mm and 0.7 mm. Structures 12 may be sensed using a simple finger scratching or rubbing as a means for the end user to verify the label's authenticity.

Each one of structures 12 may be in any color and/or hue, for example, blue, green, red, yellow, or any other color or combination of colors. Optionally, the color or colors of some or all of structures 12 may be invisible to human eyes and only identifiable by a camera. This may be done, for example, by using colors that are indistinguishable to the human eye, but can be distinguished by a camera, such as ultraviolet or infrared.

Optionally, the position, contour, color, orientation, height and/or size of each one of structures 12 are random, so no two labels are similar and label 10 is difficult to forge. Optionally, structures 12 are formed of geometrical or randomly formed pieces. Optionally, structures 12 are overlapping one another.

Optionally, structures 12 are mounted, for example printed or adhered, on top of a substrate layer 11. Reference is also made to FIG. 1B, which is an illustration of a substrate layer 11, according to some embodiments of the present invention.

Substrate layer 11 may be, for example, a thin layer of polymer material, a sticker, a cardboard piece or any other surface. Substrate layer 11 may be of any thickness, for example, 0.1, 0.3, 0.5 mm or any intermediate or larger thickness.

Optionally, Substrate layer 11 is about 0.2 mm thick.

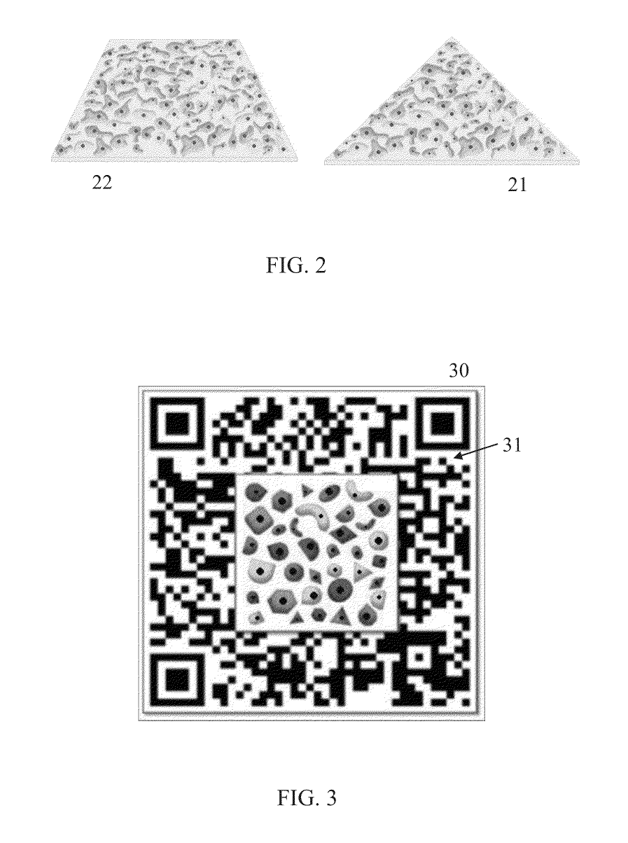

Substrate layer 11 may be designed in different shapes such as circular, square, rectangular or any other shape, as shown in FIG. 2. FIG. 2 is an illustration of a 3D label 21 shaped as a triangle and a 3D label 22 shaped as a square, according to some embodiments of the present invention.

Optionally, substrate layer 11 includes cuts 14 to ensure destruction of the label in an attempt to detach or rip it off of the product it is attached to. Cuts 14 may be, for example, at crossed directions, or at any other form according to the shape of substrate layer 11.

Optionally, structures 12 are spread over the entire area of substrate layer 11.

Optionally, an area without any structures is included on substrate layer 11 for a 2D element.

Optionally, the label includes a two dimensional (2D) element on top of the substrate. The 2D element may be, for example, a logo of a company, a machine readable code and/or proprietary coded image for scanning and identification.

Reference is now made to FIG. 3, which is an illustration of a label 30 with a quick response code (QR code) 31, according to some embodiments of the present invention. Optionally, the 2D element also includes printed features for positioning and orientation calibration such as a square frame and/or QR code fiducial markers that assist the calculation of structure 12 from the 2D image. Optionally, the 2D element is integrated with structures 12.

Some or all of structures 12 include structure parameter indicators 13.

Structure parameter indicators 13 may be, for example, a marker painted on top of a structure 12, a line, a number or any other mark usable by an image processing algorithm.

Each structure parameter indicator 13 facilitates a calculation of structure parameter of corresponding structure 12, when a single 2D image of the label is processed. The processing may be performed, for example, by an image processing algorithm. During the image processing, structure parameter indicators 13 are used by the algorithm as a point of reference.

Optionally, the color of structure parameter indicators 13 is chosen to contrast the color of the corresponding structure 12. Optionally, the size of structure parameter indicators 13 is chosen according to the size of the corresponding structure 12.

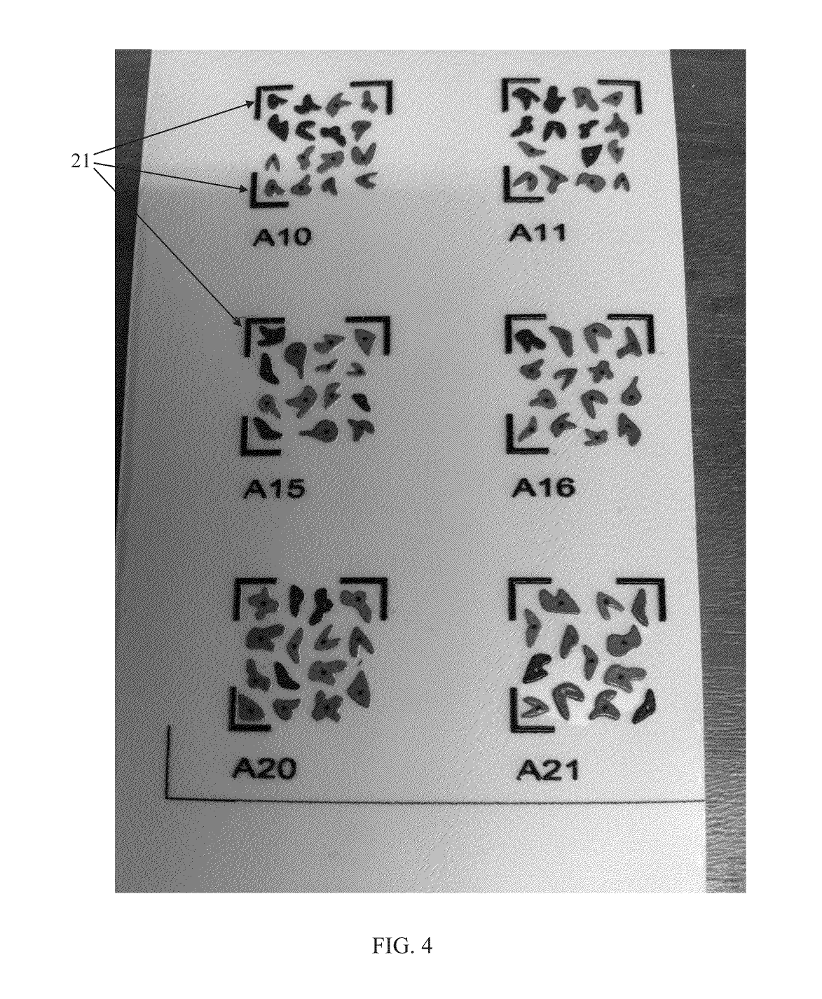

Reference is also made to FIG. 4, which is an image of an uncut substrate 40 layer with 3D structures having structure parameter indicators, according to some embodiments of the present invention. Uncut substrate 40 is prepared for cutting into labels. Optionally, the labels include calibration marks 41 for calculation the position of the imaging device acquiring the 2D image.

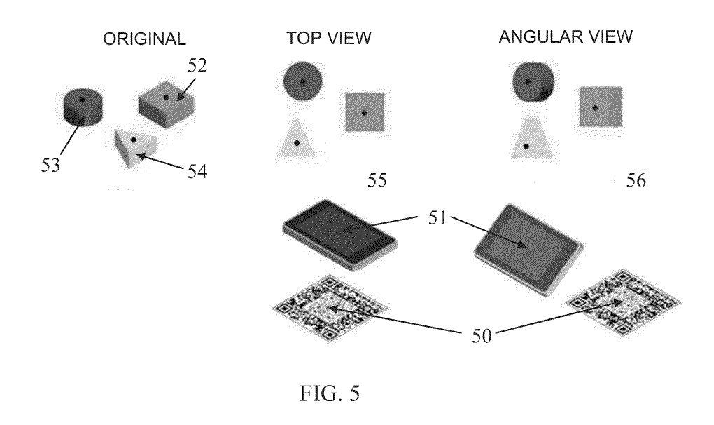

Reference is now made to FIG. 5, which is an illustration of the acquiring of an image of a label 50 by a camera of a mobile phone 51, according to some embodiments of the present invention. Each one of structures 52, 53 and 54 of label 50 includes a structure parameter indicator marker. Structures 52, 53 and 54 are presented in a top view 55 and an angular view 56. Angular view 56 may be achieved when the camera of mobile phone 51 is positioned above label 50, horizontally aligned with label 50 in one dimension and at an angle from label 50 in the other dimension. The angle may be, for example, within a detectable range of 30 to 40 degrees.

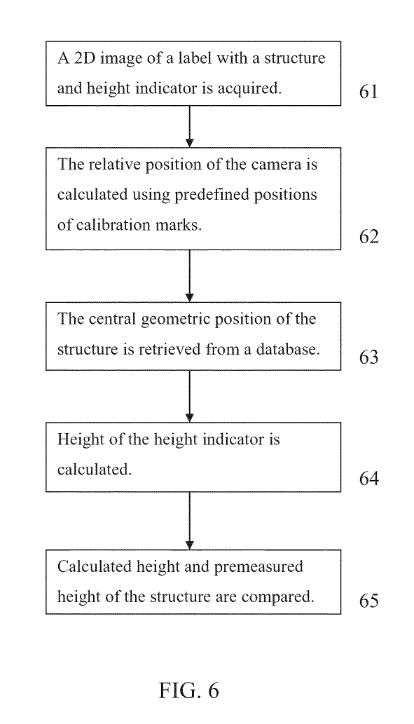

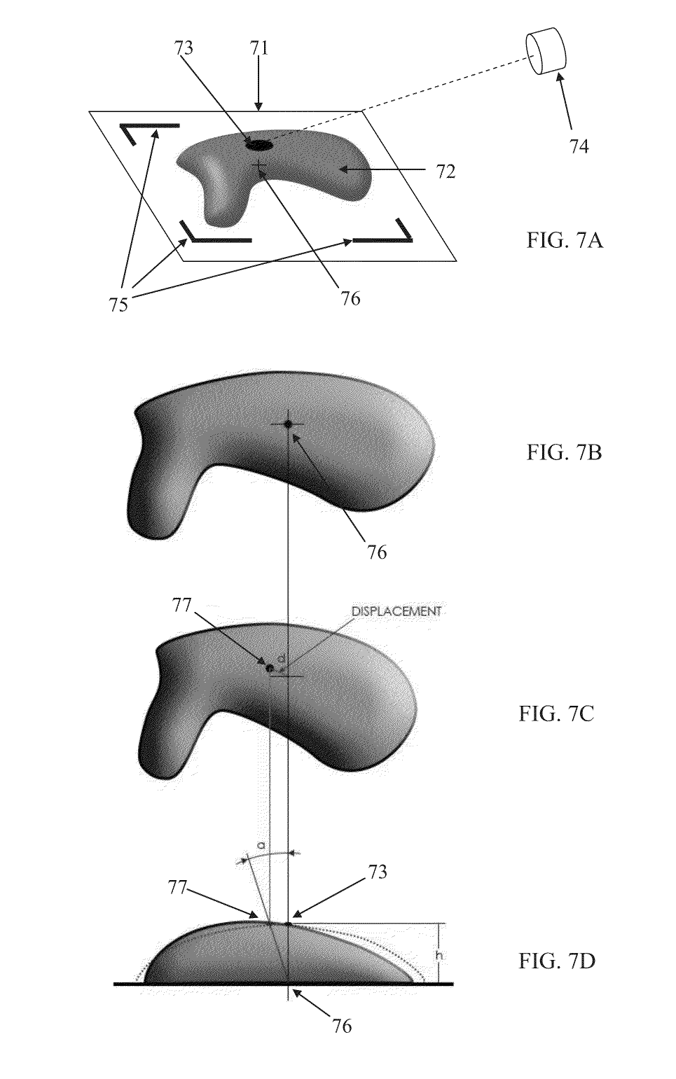

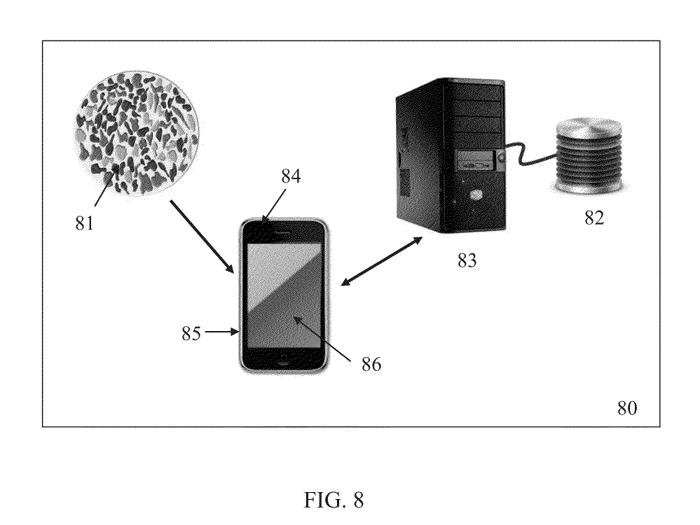

Reference is now made to FIG. 6, which is a flowchart schematically representing a method for verifying the height of an irregularly shaped three dimensional structure in a label, according to some embodiments of the present invention. Reference is also made to FIG. 7A, which is a schematic illustration of height calculation of an irregularly shaped three dimensional structure in a label, according to some embodiments of the present invention.

First, as shown at 61, a single 2D image is acquired, of a label 71 having an irregularly shaped 3D structure 72 with a height indicator 73 positioned at a central geometric position on top of structure 72. Optionally, height indicator 73 positioned at the maximal height of structure 72. The image is acquired at an angel not perpendicular to the base plane of label 71. The image is acquired by a camera 74 such as a camera of a mobile device. Optionally, the acquiring of the 2D image is triggered automatically by a mobile application installed on the mobile device when the mobile application recognizes label 71 using camera 74 of the mobile device and/or once the positioning and angle of the mobile device are found to be within a detectable range and/or usable angle.

Then, as shown at 62, the 3D relative position of camera 74 to calibration marks 75 that are printed on label 71 is calculated using the positions of calibration marks 75 in the 2D image and predefined positions of calibration marks 75.

Optionally, the predefined positions of calibration marks 75 are retrieved from a dataset. Optionally, this is performed by an algorithm implemented in a program.

Optionally, the program is a mobile application installed on the mobile device.

Then, as shown at 63, a central geometric position 76 of structure 72 is retrieved from a dataset. Optionally, central geometric position 76 is obtained from a top view image of structure 72.

Then, as shown at 64, the height of height indicator 73 is calculated using a position of height indicator 73 in the 2D image, central geometric position 76 retrieved from the database and the calculated relative position of camera 74.

Reference is now made to FIG. 7B, which is a top view of structure 72. In the top view, height indicator 73 is located on central geometric position 76. Reference is also made to FIG. 7C, which is a view of structure 72 in the 2D image taken when camera 74 is positioned to the right and slightly downwards relative to the top of structure 72. In the 2D image, the relative position 77 of height indicator 73 is within a displacement (d) from central geometric position 76.

Reference is now made to FIG. 7D, which is a side view of structure 72. The angle (a) between relative position 77, central geometric position 76 and height indicator 73 is deduced from the calculated relative position of camera 74. The height (h) of height indicator 73 is then calculated using displacement (d) and angle (a). Optionally, the calculation is simplified as a tangent trigonometric function where (a)/(h)=tan(a).

Optionally, this calculation is performed by an algorithm implemented in a program. Optionally, the program is a mobile application installed on the mobile device.

Finally, as shown at 65, the calculated height of structure 72 is compared with a premeasured height of structure 72 to authenticate a product or service associated with label 71. Optionally, the premeasured height of structure 72 is retrieved from a dataset.

Reference is now made to FIG. 8, which is an illustration of a system 80 for verifying authenticity of a label, according to some embodiments of the present invention. A label 81 having irregularly shaped 3D structures of unique structure parameters with structure parameter indicators is verified.

System 80 also includes a database 82 storing the structure parameters of the irregularly shaped 3D structures of label 81. Optionally, during or after the manufacturing of label 81, label 81 is being photographed using cameras located at different positions. The images are then encoded into a data containing all the information for the 3D structures of label 81, such as position, contour, color, orientation height and/or size, at different angles. This data is unique to label 81 and is stored in database 82. Optionally, database 82 also contains a record for the product label 81 is attached to, with reference label 81. The record may include, for example, manufacturer information, product description, product image, production date and/or any other information.

Optionally, database 82 is connected to a server 83. Server 83 may be connected to other elements of system 80 using an internet connection.

System 80 also includes an imaging device 84 for acquiring a 2D image of label 80. Optionally, imaging device 84 is a camera of a mobile phone 85. System 80 also includes a program 86 that calculates the structure parameter of the irregularly shaped 3D structures of label 81 from the 2D image, using the structure parameter indicators. Optionally, program 86 is a mobile application installed on mobile phone 85. Optionally, program 86 is connected to database 82, for example through server 83, and uses stored data of the 3D structures of label 80 to compare with structure parameter calculations made by program 86.

Optionally, when an image is acquired by imaging device 84 at an angular view 56, as shown in FIG. 5, program 86 determines the field of view of the image of label 81, including the exact positioning and angle, by analyzing the calibration marks printed on a 2D element of label 81. Optionally, program 86 automatically triggers the taking of an image once the positioning and angle of mobile phone 83 are found to be within a detectable range. Optionally, the image is geometrically transformed to a specific side angle identical to the nearest angle of label 81 photographed during or after the manufacturing, as stored on database 82, and relative to the detected angle. The image taken is analyzed by program 86 so each 3D structure of label 81 is identified. Also, the color, contour, position, height, size and/or orientation may be identified and/or measured. Optionally, a structure's height is determined as a relation between the projection of the structure as appeared in the image taken by imaging device 84 and a known projection of the structure as photographed during or after the manufacturing, stored on database 82, while the angles of both projections are known.

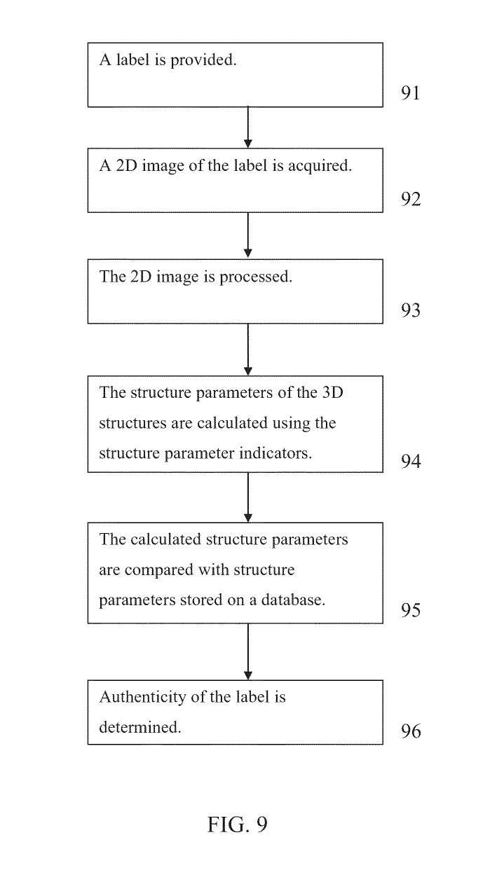

Reference is now made to FIG. 9, which is a flowchart schematically representing a method for verifying authenticity of a label, according to some embodiments of the present invention.

First, as shown at 91, a label having irregularly shaped 3D structures of unique structure parameters with structure parameter indicators is provided.

Then, as shown at 92, a 2D image of the label is acquired; this may be triggered by a user operating an imaging device, such as integrated in a mobile phone.

Then, as shown at 93, the 2D image is processed, for example, by an image processing algorithm.

Then, as shown at 94, the structure parameters of the 3D structures are calculated using the structure parameter indicators.

Then, as shown at 95, the calculated structure parameters are compared with structure parameters corresponding to the label and stored on a database.

Finally, as shown at 96, authenticity of the label is determined, according to the results of the comparison. When calculated structure parameters are similar to structure parameters stored on the database, the label is determined to be authentic.

The methods as described above are used in the fabrication of integrated circuit chips.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant three dimensional labels will be developed and the scope of the term three dimensional label is intended to include all such new technologies a priori.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A label comprising:
a plurality of randomly positioned irregularly shaped three dimensional structures of unique structure parameters; and
a plurality of structure parameter indicators each placed on top of one of said plurality of irregularly shaped three dimensional structures;
wherein each said structure parameter indicator facilitates a calculation of at least one structure parameter of a respective said irregularly shaped three dimensional structure when a single two dimensional image of said label is processed.

2. The label of claim 1, wherein a size of each said structure parameter indicator matches a size of respective said irregularly shaped three dimensional structure.

3. The label of claim 1, wherein said plurality of irregularly shaped three dimensional structures is of varying contours.

4. The label of claim 1, wherein said plurality of irregularly shaped three dimensional structures is of varying heights.

5. The label of claim 1, wherein said plurality of irregularly shaped three dimensional structures is of heights within a range of 0.2 millimeter and 0.7 millimeter.

6. The label of claim 1, wherein said plurality of irregularly shaped three dimensional structures is of varying sizes.

7. The label of claim 1, wherein said plurality of irregularly shaped three dimensional structures is of varying colors.

8. The label of claim 1, wherein said plurality of irregularly shaped three dimensional structures is positioned on top of a substrate layer.

9. The label of claim 8, wherein said substrate comprises a plurality of cuts to ensure destruction of said label on an attempt to detach said label from a product to which said label is attached.

10. The label of claim 1, wherein said plurality of irregularly shaped three dimensional structures is sensible by a finger touch, for manually validating the label authenticity.

11. The label of claim 1, further comprising a two dimensional element.

12. The label of claim 11, wherein said two dimensional element is a quick response code.

13. The label of claim 11, wherein said two dimensional element is a logo of a company.

14. The label of claim 1, further comprising a plurality of calibration marks for calculating a position of an imaging device acquiring said two dimensional image.

15. A method for verifying a height of an irregularly shaped three dimensional structure in a label, comprising:
acquiring, by a camera, a single two dimensional image of a label having an irregularly shaped three dimensional structure with a height indicator positioned at a central geometric position on top of said irregularly shaped three dimensional structure;
calculating a three dimensional relative position of said camera using positions of a plurality of calibration marks of said label in said single two dimensional image and predefined positions of said plurality of calibration marks;
retrieving from a dataset said central geometric position;
calculating a height of said height indicator using a position of said height indicator in said single two dimensional image, said central geometric position and said relative position of said camera; and
comparing said calculated height to a premeasured height of said height indicator to authenticate one of product and service associated with said label.

16. A system for verifying authenticity of a label, comprising:
an imaging device for acquiring a two dimensional image of a label having plurality of randomly positioned irregularly shaped three dimensional structures of unique structure parameters and a plurality of structure parameter indicators each placed on top of one of said plurality of irregularly shaped three dimensional structures;
a program for calculating at least one structure parameter of said plurality of irregularly shaped three dimensional structure when processing said single two dimensional image using said plurality of structure parameter indicators; and
a database storing at least one structure parameter corresponding to said label.

17. A method for verifying authenticity of a label, comprising:
providing a label having plurality of randomly positioned irregularly shaped three dimensional structures of unique structure parameters and a plurality of structure parameter indicators each placed on top of one of said plurality of irregularly shaped three dimensional structures;
acquiring a two dimensional image of said label;
processing said two dimensional image;
calculating at least one structure parameter of said plurality of irregularly shaped three dimensional structure using said plurality of structure parameter indicator;
comparing said at least one calculated structure parameter with at least one structure parameter corresponding to said label stored on a database; and
determining authenticity of said label.
